(19) United States
(12) Patent Application Publication
(10) Pub. No.: US 2002/0029552 A1
(43) Pub. Date: Mar. 14, 2002

(54) Harvesting machine, especially a self-propelled pick-up chopper

(76) Inventors: Bernard Krone, Spelle (DE); Karl-Heinz Radke, Wilthen (DE)

Correspondence Address: JORDAN & HAMBURG LLP, 122 East 42nd Street, New York, NY, 10168, US

(21) Appl. No.: 09/847,542

(22) Filed: May 2, 2001

(30) Foreign Application Priority Data
May 4, 2000 (DE) 100 21 662.5

(51) Int. Cl. A01D 34/42

(52) U.S. Cl. 56/500; 56/504

(57) ABSTRACT

The invention relates to a harvesting machine, especially a self-propelled pick-up chopper for picking up and chopping corn, wilted grass, green feed and similar harvested material, with a chopper device disposed after pick-up and feed organs. The chopper device comprises a chopper drum (1) with cutting tools (3) disposed in the circumferential direction of the chopper drum (1) at a distance from one another. In order to be able to make available a harvesting machine with an advantageous vibrational behavior and lower power requirements, the cutting tools (3) are constructed with an overlapping dimension “U” with respect to the cutting tools disposed ahead and behind in the circumferential direction.

The invention relates to a harvesting machine, especially a self-propelled pick-up chopper for picking up and chopping harvested material, such as corn, wilted grass, green feed and the like, with a chopper device, which is disposed after pick-up and feed organs and comprises a chopper drum with cutting tools disposed in the circumferential direction of the chopper drum at a distance from one another.

Increasingly, self-propelled pick-up choppers of the aforementioned type have to fulfill high cutting frequency requirements, which can be attained only at very high rotational speeds of the drum, if the latter has a small diameter of less than 700 mm. In the case of known pick-up choppers, this leads, in practice, to high noise levels and vibrations as well as to a high power consumption.

It is an object of the present invention to provide a harvesting machine of the type mentioned above, which is suitable for high cutting frequencies at a lower power consumption and a decreased noise level and less vibration. In addition, the course of the torque shall have advantageous characteristics.

For accomplishing this objective, the harvesting machine of the aforementioned type is distinguished owing to the fact that the cutting tools are constructed in each case with an overlapping dimension with respect to the cutting tools disposed ahead and behind in the circumferential direction.

With the inventive harvesting machine, high cutting frequencies can be attained already at rotational speeds of 1000 rpm. Due to the overlapping dimension of the cutting tools disposed ahead and behind in the circumferential direction, an exceptionally advantageous variation in torque can be achieved, since continuous cutting is possible due to the overlapping dimension of the cutting tools. Torque peaks are therefore avoided because of a homogenizing. By these means, very large diameters of the chopper drum can also be realized which, in the case of a relatively low weight, leads to a high moment of inertia of the chopper drum. With that, load peaks are avoided. This leads to exceptionally advantageous driving conditions. Likewise, the danger of damage with the counter cutting edge is decreased because of the improved vibrational behavior. Overall, the power requirements are decreased.

Preferably, cutting tools, disposed ahead and behind, have an overlapping dimension of 4 mm to 20 mm. Moreover, the cutting tools preferably are aligned obliquely in such a manner that the cutting process commences at a cutting tool in the outer width region of the chopper drum and progresses continuously in the direction of the center of the drum.

Advantageously, adjacent cutting tools are disposed offset to one another essentially in a V-shaped arrangement in the circumferential direction, cutting tools, which are adjacent or next to one another (in relation to the width of the chopper drum) having an overlapping dimension in relation to one another, since the cutting tools of such an arrangement, adjacent in the width, are also adjacent in the circumferential direction due to the offset dimension. The cutting tool of such an arrangement, which is the last cutting tool in the direction of rotation, then in turn forms an overlapping dimension with the first cutting tool of the next cutting tool arrangement, which leads to the continuous cutting behavior.

Preferably, the cutting tools have an oblique alignment or a steadiness angle of 8° to 13°. With the inventive pick-up choppers, chopped lengths of 3 mm to 30 mm can be attained. In this connection, 1 to 4 knives per cutting knife arrangement can be provided. A relatively large diameter can be selected for the chopper drum, so that 16 to 20 knife arrangements with 1 to 4 cutting tools can be provided next to one another distributed over the periphery. Moreover, chopper drum widths of 800 to 920 mm can readily be realized, it being assured that a cutting tool arrangement always works with a cutting range with a counter cutting edge. With that, very high cutting frequencies can be realized for the cut lengths given. With an appropriate number of knives and rotational speeds below 1000 rpm, very good vibrational behavior can be achieved. A high number of knives, in conjunction with the large widths while maintaining an angle of inclination or a steadiness angle in the given range, ensure the aimed-for overlap between the cutting tools disposed ahead and behind. Cutting tool superimpositions due to oscillations on a counter tool are also avoided.

Further details of the invention arise out of the following description and the drawing in which,

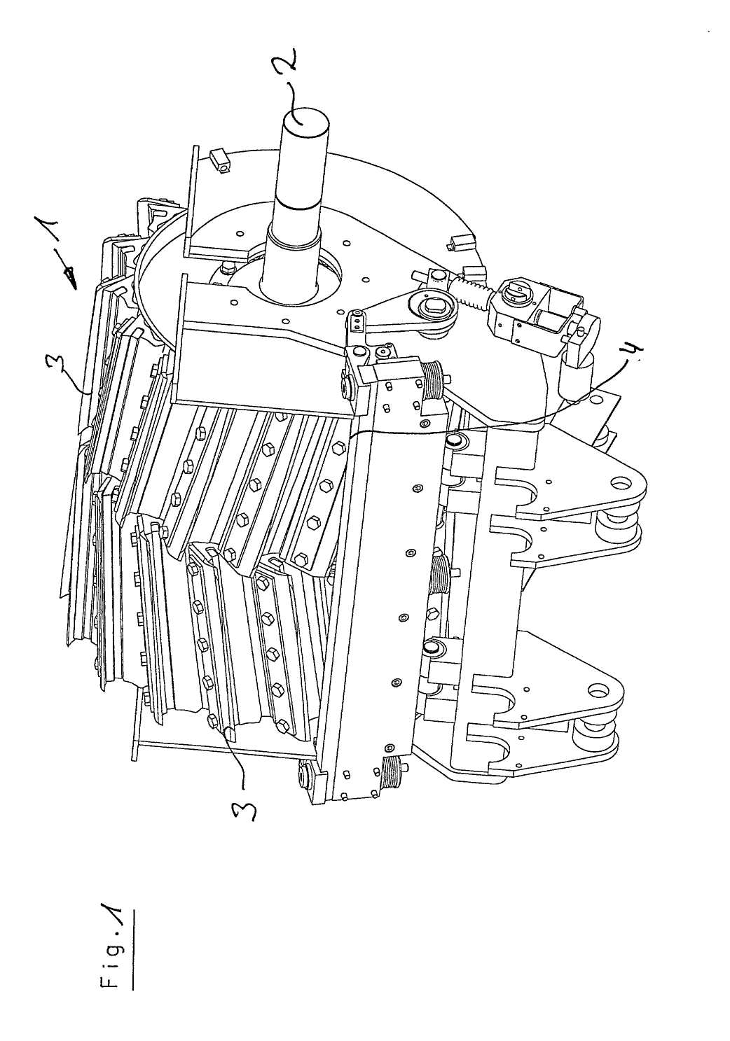

FIG. 1 shows a perspective front view of an example of a chopper drum for an inventive harvesting machine,

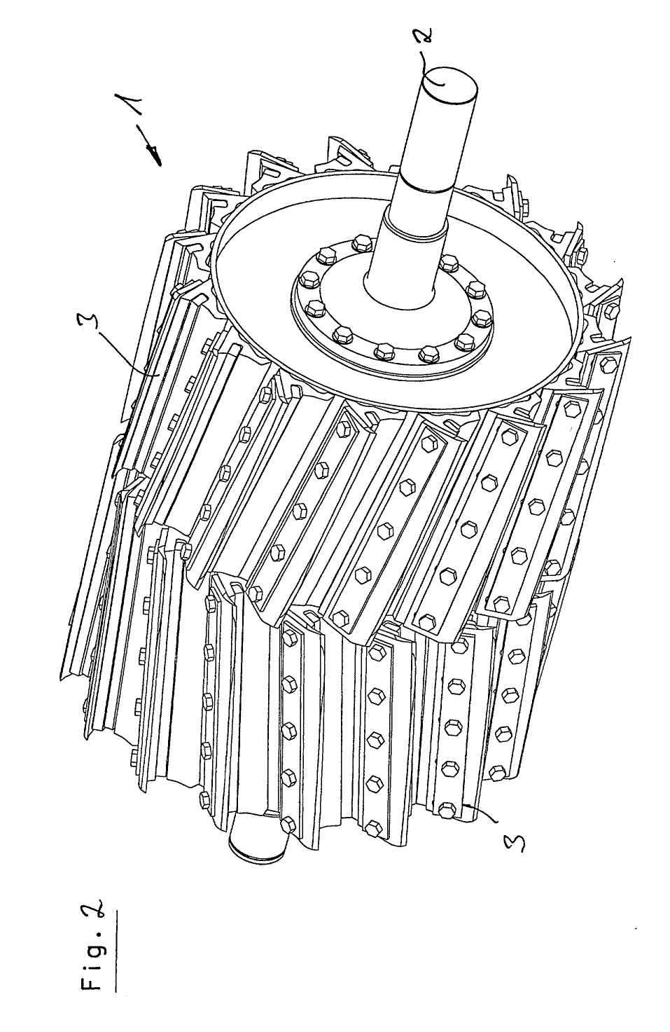

FIG. 2 shows a detailed representation of the drum, similar to FIG. 1 and

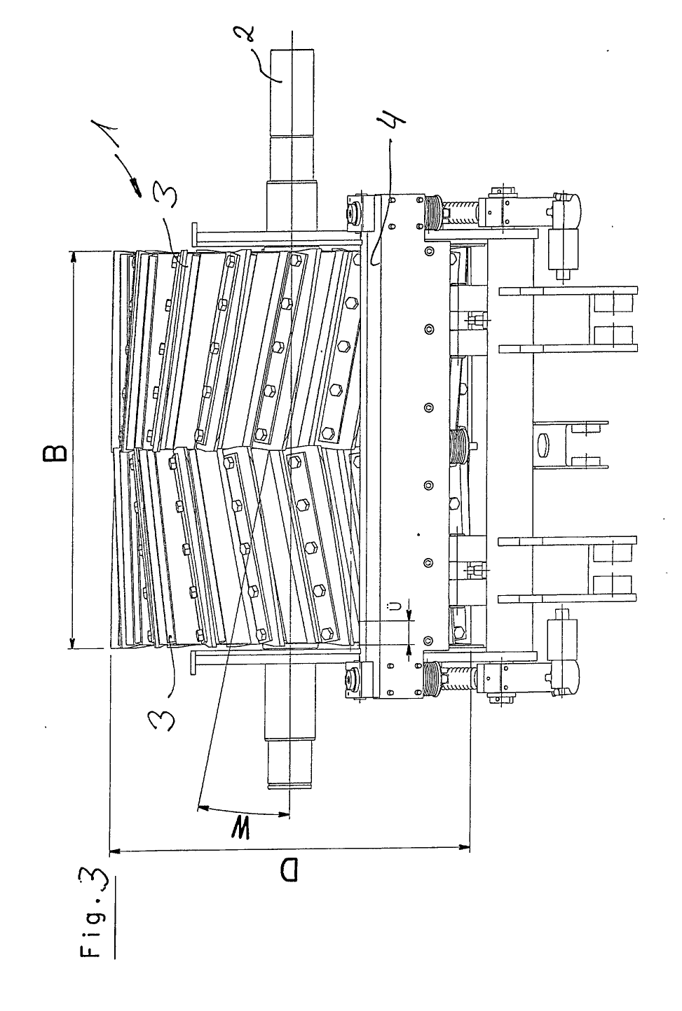

FIG. 3 shows a front view of the example of FIG. 1.

In the Figures, parts having the same effect have the same reference numbers. For the sake of greater clarity, a representation of the whole harvesting machine is not shown. The chopper drum of a chopping device for a harvesting machine is labeled 1 and is disposed after the pick-up and feeding organs of the harvesting machine. It is driven over a drive shaft 2 and over transmission and motor units, the details of which are not shown. On the periphery of the drum 1, cutting tools 3, namely cutting knifes, are disposed offset. In the case of the examples shown, these cutting tools 3 are disposed in two rows over the width of the drum 1 and, moreover, in each case in such a manner that they are aligned essentially in an offset V-shaped arrangement with the V tip approximately in the center of the drum 1. The oblique arrangement of the cutting tools 3 is selected in such a manner that, for a drum width of between 800 mm and 920 mm, an angle of slope within the range of 8° to 13° is provided.

The cutting knives 3, disposed ahead and behind, are aligned in such a manner and have a length so matched to one another, that cutting knives, disposed ahead and behind, in each case have an overlap “U” (FIG. 3), so that there is always, continuously, an effective cutting region for the material harvested at the counter blade 4. By means of this alignment and the overlapping dimension, 16 to 20 cutting knife arrangements, which are formed in the example shown by in each case 2 of the V-shaped cutting knives, can be realized at the aimed-for drum widths of 800 to 920 mm and a drum diameter ranging from 720 mm to 850 mm. Alternatively, however, 1, 3 or also 4 cutting knives per cutting knife arrangements can also be provided. Overall, a harvesting machine with an above-described chopper drum has an exceptionally favorable vibrational and noise behavior. Such a harvesting machine is also suitable for chopped lengths of 3 mm to 30 mm at high cutting frequencies.

1. The invention relates to a harvesting machine, especially a self-propelled pick-up chopper for picking up and chopping corn, wilted grass, green feed and similar harvested material, with a chopper device, which is disposed after pick-up and feed organs and comprises a chopper drum (1) with cutting tools (3) disposed in the circumferential direction of the chopper drum (1) at a distance from one another, wherein the cutting tools (3) are constructed with an overlapping dimension “U” with respect to the cutting tools (3) disposed in each case ahead and behind in the circumferential direction.

2. The harvesting machine of claim 1, wherein the cutting tools (3), disposed in each case ahead and behind, have an overlapping dimension “U” of 4 to 20 mm.

3. The harvesting machine of claim 1 or 2, wherein adjoining cutting tools (3) are disposed offset to one another in the circumferential direction of the chopper drum (1) essentially in a V-shaped arrangement.

4. The harvesting machine of claim 3, wherein the cutting tools (3) are aligned obliquely to the horizontal at an angle of 8° to 13°.

5. The harvesting machine of one of the claims 1 to 4, wherein 16 to 20 cutting tool arrangements with, in each case, 1 to 4 cutting tools (3) are provided in the circumferential direction of the chopper drum (1).

6. The harvesting machine of one of the claims 1 to 5, wherein the chopper drum (1) has a diameter greater than 700 mm and a width greater than 800 mm.
